(19) United States
(12) Patent Application Publication
(10) Pub. No.: US 2026/0048580 A1
(43) Pub. Date: Feb. 19, 2026

(54) METHODS AND SYSTEMS FOR ELECTROCHEMICAL POLYMERS DELAMINATION

(71) Applicant: Ohio State Innovation Foundation, Columbus, OH (US)

(72) Inventors: Melvin A. PASCALL, Columbus, OH (US); Elliot DHUEY, Sun Prairie, WI (US)

(21) Appl. No.: 19/103,662

(22) PCT Filed: Aug. 21, 2023
(86) PCT No.: PCT/US2023/030698

§ 371 Date: Feb. 13, 2025

Related U.S. Application Data
(60) Provisional application No. 63/399,776, filed on Aug. 22, 2022.

(51) Int. Cl. B32B 43/00

(52) U.S. Cl. CPC B32B 43/006; B32B 2310/021; B32B 2310/0418; B32B 2311/16; B32B 2311/30; B32B 2439/66; B32B 2439/70

(57) ABSTRACT

Disclosed is a method of electrochemical delamination of polymeric films from metallic articles. Also disclosed are systems for achieving the same.

### CROSS-REFERENCE TO RELATED APPLICATIONS

This application claims the benefit of U.S. Provisional Application No. 63/399,776, filed Aug. 22, 2022, the content of which is incorporated herein by reference in its entirety.

### STATEMENT ACKNOWLEDGING GOVERNMENT SUPPORT

This invention was made with government support under Grant No. 20176701726469, awarded by the United States Department of Agriculture-National Institute of Food and Agriculture. The government has certain rights in the invention.

### TECHNICAL FIELD

This application relates generally to the electrochemical removal of corrosion-resistant polymeric coatings from metal cans used to package food.

### BACKGROUND

A metal can is an excellent tool commonly used in the food industry to extend the shelf life of various commodities because these containers have a high barrier to gases, vapors, light, filth, and microorganisms. At the same time, the complexity of canned food varies greatly from one another, and many natural and added ingredients are known to contribute to the initiation of corrosion in metal packaging. Corrosion is a chemical reaction between a metal and its environment to form derivative compounds of the metal. This involves the transfer of an electrical charge across the boundary between the metal surface and the environment. Examples of food components known to accelerate this corrosion include oxygen, pigments, nitrates, sulfur compounds, sodium chloride and trimethylamines.

In response to this need to protect metallic food cans from corrosion before being opened by consumers, the metal packaging industry developed and deployed several coating technological approaches. As an example, the metallic walls of these cans are usually composed of a steel layer over which is a tin-iron alloy layer followed by an enamel coating. However, in selecting a suitable protective coating for food cans, consideration must be given to the nature of the food plus the method used to process the packaged product. Thus, in the case of heated retort-processed canned foods, to make a reasonable choice in this matter, it is essential to gain an understanding of the following chemistries: (1) how ingredients in the recipe of the unprocessed food are capable of initiating corrosion; (2) how ingredients in the recipe and compounds that arise in the product after being subjected to heat may initiate corrosion; (3) after heat treatment and during storage, how do all ingredients in the food attack the protective coating of the cans and thus expose the base metal; and (4) how these ingredients initiate corrosion in the subsurface base metal of the cans.

Before selecting a suitable coating for metal cans to be used for packaging a given food, it is essential that the corrosion resistance of the coating is adequate to withstand chemical modification from the heat treatment process and the chemical compounds within the food. This includes compounds that may arise as a result of the heat treatment (retorting) of the package. In order to gain this knowledge, it will be necessary to identify and quantify the volatile and nonvolatile compounds associated with the food under the retort conditions. It will also be important to understand which compounds are responsible for causing corrosion in retorted cans. To determine this, it will be necessary to measure the quantities of the compounds of concern in the food product and the quantities that would migrate to the coating of the metal cans and to understand how these migrating compounds would affect the properties of the coating. If the coating is compromised during the heat treatment, it will lose its protective properties and electrolytes and water in the food would then be capable of reaching the base metal in the container and thus initiate corrosion.

However, to test the coating's chemical, physical, thermal and barrier properties before and after exposure to the heat processing conditions within the food-filled metal cans, it will be necessary to remove the coating from the base metal, then test it as desired. This coating must be removed without affecting its properties to be accurately analyzed using scientifically acceptable analytical procedures. This is a challenge that must be addressed in order to produce reliable results and thus make reasonable conclusions about the performance of the coating.

Thus, methods and systems allowing the delamination of the coatings and analyzing their compositions are still needed. These needs and other needs are at least partially satisfied by the present disclosure.

### SUMMARY

The present disclosure is directed to a method comprising: a) providing an electrochemical cell comprising an electrolyte solution positioned within an electronically non-conductive vessel; wherein the electrochemical cell further comprises a cathode terminal and an anode terminal; b) positioning a metallic article into the electrolyte solution, wherein the metallic article has a first surface and a second surface, wherein at least one of the first or the second surfaces is coated with at least one polymeric layer having a predetermined thickness; and wherein the metallic article is coupled to the cathode terminal; c) applying a current to the metallic article for a first predetermined time, wherein the current has a predetermined value effective to substantially delaminate the at least one polymeric layer, thereby forming a delaminated polymeric layer; and d) collecting the delaminated polymeric layer, wherein a composition of the delaminated polymeric layer is substantially the same as a composition of the at least one polymeric layer.

In still further aspects, the disclosure is directed to the method wherein the anode terminal is coupled to a reference metallic article, wherein the reference metallic article is substantially free of any coatings.

In still further aspects, the disclosure is directed to a method comprising: a) providing an electrochemical cell comprising an electrolyte solution positioned within an electronically non-conductive vessel; wherein the electrochemical cell further comprises a cathode terminal and an anode terminal; b) positioning a metallic food container into the electrolyte solution, wherein the metallic food container is substantially empty of food items and has a first surface and a second surface, wherein at least one of the first or the second surfaces is coated with at least one polymeric layer having a predetermined thickness; and wherein the metallic food container is coupled to the cathode terminal; c) applying a current to the metallic food container for a first predetermined time, wherein the current has a predetermined value effective to substantially delaminate the at least one polymeric layer, thereby forming the delaminated polymeric layer; d) collecting the delaminated polymeric layer, e) comparing a composition of the delaminated polymeric layer with a composition of a substantially identical polymeric layer coated on the at least one of the first or the second surfaces before it contacts the food item.

In still further aspects, the disclosure is directed to a system comprising: an electronically non-conductive vessel comprising an electrolyte solution and wherein the electronically non-conductive vessel comprises a cathode terminal and an anode terminal; and a metallic article configured to be positioned within the electrolyte solutions and be coupled to the cathode terminal; wherein the metallic article is a food container comprising at least one polymeric layer on at least one surface of the metallic article and wherein the system is configured to delaminate the at least one polymeric layer and to form at least one delaminated polymeric layer, wherein a composition of the at least one delaminated polymeric layer is substantially identical to a composition of the at least one polymeric layer.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIG. 1 depicts an exemplary system configured to perform methods disclosed in some aspects.

FIG. 2 depicts XRD patterns of unprocessed and processed cans and lining in tomatoes.

FIG. 3 depicts XRD patterns of unprocessed and processed lining in tomatoes.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### DEFINITIONS

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,”and “the”include plural referents unless the context clearly dictates otherwise.

Thus, for example, a reference to “an electrochemical cell” includes two or more such electrochemical cells, reference to “a metallic article” includes two or more such metallic articles and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that although the terms “first,” “second,” etc., may be used herein to describe various elements, components, regions, layers, and/or sections.

These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80 %, at least about 85 %, at least about 90 %, at least about 91 %, at least about 92 %, at least about 93 %, at least about 94 %, at least about 95 %, at least about 96 %, at least about 97 %, at least about 98 %, at least about 99 %, or about 100 % of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1 % by weight, e.g., less than about 0.5 % by weight, less than about 0.1 % by weight, less than about 0.05 % by weight, or less than about 0.01 % by weight of the stated material, based on the total weight of the composition.

As used herein, the terms “substantially identical reference composition” or “substantially identical reference article” refer to a reference composition or article comprising substantially identical components in the absence of an inventive component. In another exemplary aspect, the term “substantially,” in, for example, the context “substantially identical reference composition,” or “substantially identical reference article,” refers to a reference composition, or article, comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### METHODS

As disclosed above, the current disclosure is directed to a method comprising: a) providing an electrochemical cell comprising an electrolyte solution positioned within an electronically non-conductive vessel; wherein the electrochemical cell further comprises a cathode terminal and an anode terminal; b) positioning a metallic article into the electrolyte solution, wherein the metallic article has a first surface and a second surface, wherein at least one of the first or the second surfaces is coated with at least one polymeric layer having a predetermined thickness; and wherein the metallic article is coupled to the cathode terminal; c) applying a current to the metallic article for a first predetermined time, wherein the current has a predetermined value effective to substantially delaminate the at least one polymeric layer, thereby forming a delaminated polymeric layer; and d) collecting the delaminated polymeric layer, wherein a composition of the delaminated polymeric layer is substantially the same as a composition of the at least one polymeric layer.

It is understood that the electronically non-conductive vessel can have any desired dimensions that are compatible with the specific application. In yet still further aspects, the electronically non-conductive vessel can be made of plastic material, glass, plexiglass, ceramic, or any other material that is electronically isolating.

In further aspects, the method can comprise positioning two or more metallic articles into the electrolyte solution to increase the throughput of delamination and collection of the polymeric films. In such aspects, the metallic articles can be attached in parallel. In such aspects, each of the additional metallic articles is also connected to an additional reference metallic article.

In still further aspects, the metallic article can comprise any metal. In yet still further aspects, the metallic article is a tin-coated steel article. It is understood that any known in the art steel compositions can be used to form the article. In still further aspects, the metallic article can comprise aluminum, tin-free steel, chromium-coated steel and alloys with metals such as magnesium and the like.

In still further aspects, the anode terminal is coupled to a reference metallic article, wherein the reference metallic article is substantially free of any coatings. In some aspects, the reference metallic article can be substantially identical to the metallic article with the absence of the at least one polymeric layer. In such aspects, the reference metallic article can have dimensions substantially identical to the metallic article used for the delamination of the film. In yet other aspects, the reference metallic article can be any conductive article.

In still further aspects, the current is a direct current (DC) having a value from about 2 A to about 75 A, including exemplary values of about 5 A, about 7 A, about 10 A, about 12 A, about 15 A, about 17 A, about 20 A, about 22 A, about 25 A, about 27 A, about 30 A, about 32 A, about 35 A, about 37 A, about 40 A, about 42 A, about 45 A, about 47 A, about 50 A, about 52 A, about 55 A, about 57 A, about 60 A, about 62 A, about 65 A, about 67 A, about 70 A, and about 72 A.

In still further aspects, the first predetermined time is from about 1 s to about 24 h, including exemplary values of about 10 s, about 30 s, about 1 min, about 15 min, about 30 min, about 45 min, about 1 h, about 5 h, about 10 h, about 15 h, and about 20 h.

In still further aspects, the electrolyte solution can comprise any aqueous ion-conductive solution. In some aspects, the electrolyte solution can have a pH from about 5.5 to about 8, including exemplary values of about 6, about 6.5, about 7, and about 7.5.

In still further aspects, the electrolyte solution does not comprise a strong acid or a caustic solution. It is understood that the term “caustic,” as used herein, refers to strong bases. In still further aspects, it is understood that the terms “strong acid” and “strong base” are used as it is common in the industry and refer to acids and/or bases that are completely or nearly 100% ionized in their solutions.

In still further aspects, the electrolytes of the current disclosure comprise aqueous solutions of salts selected from NaCl, KCl, CaCl₂, NaNO₃, CaCO₃, Ca(HCO₃)₂, Na₂CO₃, NaHCO₃, NaSO₄, or any combination thereof. In still further aspects, the salt can be present in a concentration from about 1% w/v to about 50% w/v, including exemplary values of about 5% w/v, about 10% w/v, about 15% w/v, about 20% w/v, about 25% w/v, about 30% w/v, about 35% w/v, about 40% w/v, and about 45% w/v of the solution.

In yet other aspects, the electrolyte solution can have a conductivity of 65 mS/cm to 100 mS/cm, including exemplary values of about 70 mS/cm, about 75 mS/cm, about 80 mS/cm, about 85 mS/cm, about 90 mS/cm, and about 95 mS/cm. This would vary depending on the selected salt.

In still further aspects, the at least one polymeric layer can comprise one or more of polyolefin, polyamide, polyurethane, polyester, acrylic, epoxy, oleoresin, vinyl, or any combination thereof. In yet still further aspects, the at least one polymeric layer further comprises one or more of crosslinking agents, plasticizers, processing aids, coloring agents, or any combination thereof. While in still further exemplary and unlimiting aspects, the at least one polymeric layer can comprise a bisphenol A-diglyceryl ether epoxy, vinyl organosols, phenolics, or any combination thereof.

In still further aspects, the first predetermined thickness can be anywhere from about 50 nm to about 5 cm, including exemplary values of about 100 nm, about 500 nm, about 1 micron, about 50 microns, about 100 microns, about 500 microns, about 1,000 microns, about 5,000 microns, about 1 cm, about 2 cm, about 3 cm, and about 4 cm.

In still further aspects, the methods of the disclosure are performed at room temperature. In yet still further aspects, the methods of the disclosure are performed at a temperature from about 20° C. to about 60° C., including exemplary values of about 25° C., about 30° C., about 35° C., about 40° C., about 45° C., about 50° C., and about 55° C.

In still further aspects, the methods of the present disclosure can comprise a step of applying an ultrasonic frequency during the duration of at least step c) and/or at least step d). Without wishing to be bound by any theory, it is assumed that ultrasonic energy can assist in the further delamination of the at least one polymeric film. In such aspects, the ultrasonic frequency is provided by an ultrasonic generator.

In still further aspects, the metallic article is a food container. In such aspects, in the methods of the disclosure the at least one polymeric layer has been in intimate contact with at least one food item for a second predetermined time. It is understood that in some aspects, the food was in contact with the at least one polymeric layer at room temperature. Yet, in other aspects, for at least a portion of the second predetermined time, the food was in contact with the at least one polymeric layer when the metallic article was at an elevated temperature. In some aspects, the elevated temperature can be anywhere from about 30° C. to about 200° C., including exemplary values of about 40° C., about 50° C., about 60° C., about 70° C., about 80° C., about 90° C., about 100° C., about 110° C., about 120° C., about 130° C., about 140° C., about 150° ., about 160° C., about 170° C., about 180° C., about 190° C. In yet still further aspects, it is understood that the metallic article containing food items can be subjected to a temperature variations anywhere from about 20° C. to about 200° C., including exemplary values of about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C.

In still further aspects, the second predetermined time can be from about 30 sec to about 5 years, including exemplary values of about 1 min, about 1 h, about 10 h, about 24 h, about 48 h, about 72 h, about 96 h, about 120 h, about 1 week, about 1 month, about 6 months, about 1 year, about 2 years, about 3 years, and about 4 years. In yet still further aspects, the second predetermined time can be greater than 10 years.

In still further aspects, the method disclosed herein can comprise a step of comparing a composition of the delaminated polymeric layer with a composition of a substantially identical virgin polymeric layer that has not been in intimate contact with the at least one food item at any time.

Also disclosed herein is a method comprising: a) providing an electrochemical cell comprising an electrolyte solution positioned within an electronically non-conductive vessel; wherein the electrochemical cell further comprises a cathode terminal and an anode terminal; b) positioning a metallic food container into the electrolyte solution, wherein the metallic food container is substantially empty of food items and has a first surface and a second surface, wherein at least one of the first or the second surfaces is coated with at least one polymeric layer having a predetermined thickness; and wherein the metallic food container is coupled to the cathode terminal; c) applying a current to the metallic food container for a first predetermined time, wherein the current has a predetermined value effective to substantially delaminate the at least one polymeric layer, thereby forming the delaminated polymeric layer; d) collecting the delaminated polymeric layer, e) comparing a composition of the delaminated polymeric layer with a composition of a substantially identical polymeric layer coated on the at least one of the first or the second surfaces before it contacts the food item.

In yet still further aspects, the composition of the delaminated polymeric layer is substantially the same as a composition of the at least one polymeric layer prior to step c).

### SYSTEM

Further disclosed herein is a system comprising: an electronically non-conductive vessel comprising an electrolyte solution and wherein the electronically non-conductive vessel comprises a cathode terminal and an anode terminal; and a metallic article configured to be positioned within the electrolyte solutions and be coupled to the cathode terminal; wherein the metallic article is a food container comprising at least one polymeric layer on at least one surface of the metallic article and wherein the system is configured to delaminate the at least one polymeric layer and to form at least one delaminated polymeric layer, wherein a composition of the at least one delaminated polymeric layer is substantially identical to a composition of the at least one polymeric layer.

Any of the disclosed above metallic articles can be utilized. In still further aspects, the system can further comprise a reference metallic article, wherein the reference metallic article is substantially free of any coatings. It is understood that any of the disclosed above reference metallic articles can be used.

In still further aspects, the system can comprise a control unit, wherein the control unit is configured to deliver a direct current (DC) having a value from about 2 to about 75 A, including exemplary values of about of about 5 A, about 7 A, about 10 A, about 12 A, about 15 A, about 17 A, about 20 A, about 22 A, about 25 A, about 27 A, about 30 A, about 32 A, about 35 A, about 37 A, about 40 A, about 42 A, about 45 A, about 47 A, about 50 A, about 52 A, about 55 A, about 57 A, about 60 A, about 62 A, about 65 A, about 67 A, about 70 A, and about 72 A to the metallic article, thereby causing delamination of the at least one polymeric layer. It is understood that DC can be provided as a continuous current or as pulsating current.

In still further aspects, the system further can also comprise an ultrasonic generator configured to provide a predetermined ultrasonic frequency.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C or is at ambient temperature, and pressure is at or near atmospheric.

### Example 1

The purpose of this method is to remove laminated or other bonded coatings that are adhered to the surface of metal substrates.

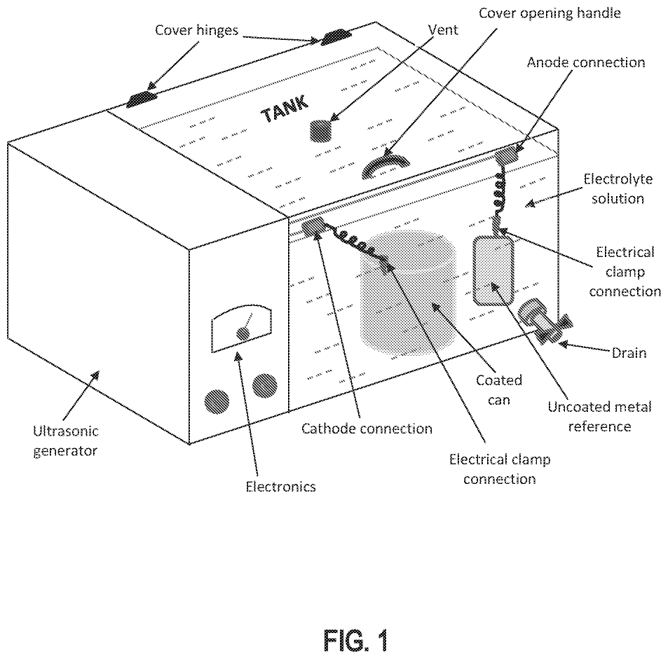

FIG. 1 shows a view of the disclosed system allowing coating removal from the metal cans without physical damage or changes to its physio-chemical structure. The device is made of two main compartments. One compartment houses the electronics of the equipment. The other compartment is a water-resistant tank made from a non-conductive material, such as glass, plexiglass, ceramic, etc.

The equipment is an electronic device with a minimum output voltage of 12 Volts and a current range between 2 to 75 Amps. The exemplary drawing shows a 12-volt battery charger housed within the electronic compartment of the device. This exemplary charger is designed to produce 12 amps of pulsating direct current (DC). This current is conveyed via electrical wires to positive (cathode) and negative (anode) electrodes located on the wall of the tank. In FIG. 1, they are shown on the front panel of the invention. Each electrode has an insulated wire that ends in metal clamps. These wires and the clamps are immersed in the tank that is filled with an electrolyte made with a 10% w/v solution of sodium carbonate. As an option, the clamps could be positioned to hold the metal can and the reference above the electrolyte. This will reduce wear on the clamps from the electro-chemistry of the device. This electrolyte could be substituted for another appropriate salt solution.

The test sample can be composed of a metal substrate with an organic, inorganic, metallic or composite coating. The samples can be cut into 4-inch by 2-inch sections using metal shears or other appropriate cutting devices. The dimensions of the cut sample can vary depending on the size of the tank and the ability to attach the samples to the electrode clamps. Before attaching the samples to the clamps, an abrasive tool or another device, such as steel wool, can be used to remove any insulating material from the base metal. This can allow the clamps to directly contact the metallic surface. The sample can then be clamped to the negative electrode, and the reference uncoated metallic sample of a similar dimension can be clamped to the positive electrode.

The metal can with the polymeric coating that is to be delaminated is then submerged in the tank with the electrolyte solution. The wire that is connected to the anode is then clamped to the metal can. To ensure that the clamp is in contact with the base metal, the place where the clamp is to contact the can must be cleaned with an appropriate tool so that any coating in that location is removed. The clamp that is connected to the cathode is then connected to an uncoated metal sheet that serves as a reference. This reference is also submerged in the electrolyte in the tank and is not made to contact the coated metal can.

Once the current from the 12-volt battery charger begins circulating into the tank with the can and the metal reference, the coating will begin to delaminate from the metallic wall of the can. If the coating does not completely detach from the metal, it can be removed using a pair of forceps or another appropriate tool. The average time for coating removal can be approximately 2-3 hours. However, this may vary depending on the size and composition of the sample, the concentration and type of the electrolyte solution, and the applied current. Once the coating begins to delaminate, the electronic device is powered down, and the sample unclamped for manual removal of the coating if so desired.

The submersion tank is also equipped with a transducer that propagates an ultrasonic signal in the form of ultrasonic vibrations through the electrolyte solution. The frequency of the ultrasonic waves is 40 kilocycles; however, the frequency can range from 4 to over 400 kilocycles depending on the volume of liquid and the nature of electrolytes. The vibrations will aid in lifting the coating from the metal substrate and accelerate the reactions occurring.

During the delamination of the coating, the electrolyte will generate a gas that must be expelled through a vent in the cover of the invention. This cover can be opened by gripping the handle located near the front of the device. Two hinges at the back side of the device allow the cover to swing open vertically. It also allows a technician to conveniently fill the tank with the electrolyte. The tank can be emptied by opening a valve located on the lower right-hand side of the tank, as shown in FIG. 1.

### Example 2

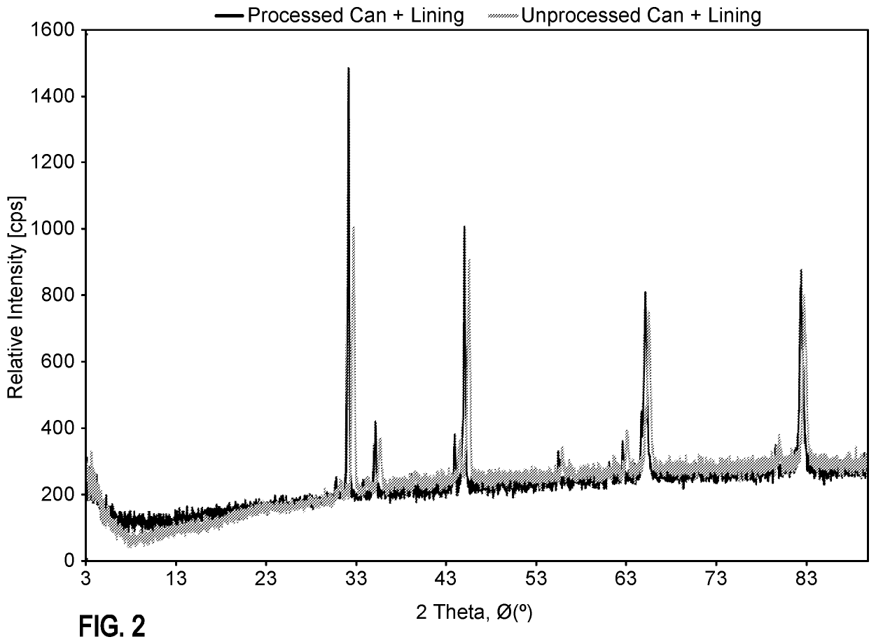

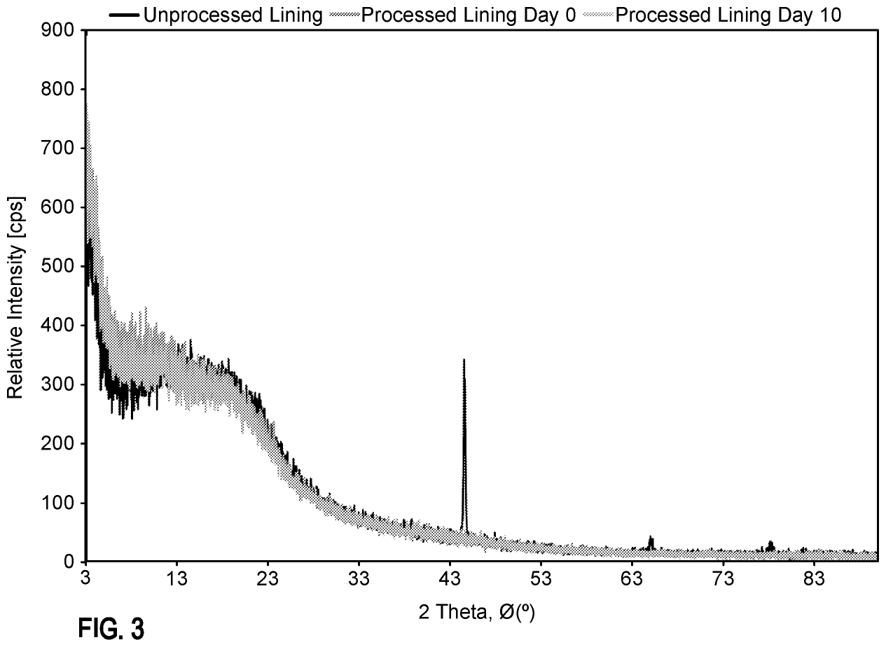

In contrast with FIG. 3, FIG. 2 shows the X-ray diffraction patterns of unprocessed and processed samples with the lining bonded to the can. The retort processed sample was filled with tomato and stored at 49° C. for 50 days using XRD.

The diffractograms show crystalline patterns for the metal and polymeric structures.

These X-ray diffraction patterns are consistent with findings from a corrosion study on a tin-plated material exposed to a salt solution (Ma et al., 2018). Ma et al. (2018) concluded that defects in the tin-plated layer resulted from exposure of the steel layer to the electrolyte solution, resulting in corrosion of the metal surface. The peaks shown on the diffractograms in FIG. 2 increased in intensity after the can was processed when compared with the unprocessed can. The resultant increase in the intensity of the peaks after processing and aging of the can indicates that there was low temperature recrystallization of the tin in the metal. This low temperature recrystallization of tin was reported in the literature by Paine et al. (1999). Without wishing to be bound by any theory, it is hypothesized that the delamination resulted in the recrystallization of the tin, as shown in the X-ray diffractogram.

FIG. 3 shows the X-ray diffraction patterns of the polymeric linings before and after processing. These diffractograms are of the linings after they were removed from the metal surfaces. The unprocessed lining shows 4 strong peaks at 2θ=18.2, 44.4, 64.7, and 77.8. Whereas the processed lining shows a singular peak at 2θ=18.2. Paul and Sindhu (2014) found that peaks at 2θ=45.3, 65.7 and 78.8 are characteristic of aluminum, and 17.8 is characteristic of an epoxy resin. Similar diffractograms were reported by Bello et al. (2018), where aluminum particles were incorporated into an epoxy composite. Various nanoparticles, like aluminum, are added to epoxy resins in order to fill small voids and increase the tortuosity of the lining and inhibit corrosive compounds which can diffuse through the resin to the metal surface of the can (Shi et al., 2009; Alam et al. 2017; Yang et al. 2018). FIG. 3 shows that after processing, the crystalline aluminum is no longer present in the polymeric matrix. These changes could have been due to the loss and/or change of plasticizers in the epoxy polymer lining. Plasticizers interact with polymers to increase their flexibility by increasing the spaces between adjacent polymeric chains (Mouritz 2012). Therefore, the interaction of dimethyl sulfide or other sulfides produced during the retorting process and which were adsorbed into the can lining may have changed the polymer chemistry by impacting the role of the plasticizers.

Additionally, the heat of the retorted process was capable of evaporating some of the plasticizers from the polymer (Marcilla and Beltrán 1998). This could have the effect of decreasing the spaces between the polymeric chains. Additionally, it should be noted that the literature reports that epoxy resins are notorious for high water uptake, especially at high temperatures such as in a retort (Zhou and Lucas 1999). This also can potentially change the polymer's thermomechanical properties, including that of the glass transition temperature and crystallinity due to chain scission and secondary crosslinking (González et al. 2012). In conclusion, the combination or independent action of tomato compounds like dimethyl sulfide and water present in the can may have impacted the epoxy lining by changing the void spaces within the polymeric matrix, which increased available pathways for corrosive compounds to contact the metal surface.

### EXEMPLARY ASPECTS

Example 1. A method comprising: (a) providing an electrochemical cell comprising an electrolyte solution positioned within an electronically non-conductive vessel; wherein the electrochemical cell further comprises a cathode terminal and an anode terminal; (b) positioning a metallic article into the electrolyte solution, wherein the metallic article has a first surface and a second surface, wherein at least one of the first or the second surfaces is coated with at least one polymeric layer having a predetermined thickness; and wherein the metallic article is coupled to the cathode terminal; (c) applying a current to the metallic article for a first predetermined time, wherein the current has a predetermined value effective to substantially delaminate the at least one polymeric layer, thereby forming a delaminated polymeric layer; and (d) collecting the delaminated polymeric layer, wherein a composition of the delaminated polymeric layer is substantially the same as a composition of the at least one polymeric layer.

Example 2. The method of any one of examples herein, particularly example 1, wherein the anode terminal is coupled to a reference metallic article, wherein the reference metallic article is substantially free of any coatings.

Example 3. The method of any one of examples herein, particularly example 1 or 2, wherein the current is a direct current (DC) and has a value from about 2 to about 75 A.

Example 4. The method of any one of examples herein, particularly examples 1-3, wherein the metallic article is a tin-coated steel article.

Example 5. The method of any one of examples herein, particularly examples 1-4, wherein the first predetermined time is from about 1 s to about 24 hours.

Example 6. The method of any one of examples herein, particularly examples 1-5, wherein the electrolyte solution has a pH from about 5.5 to about 8.

Example 7. The method of any one of examples herein, particularly examples 1-6, wherein the electrolyte solution is not a strong acid or a caustic solution.

Example 8. The method of any one of examples herein, particularly examples 1-7, wherein the at least one polymeric layer comprises one or more of polyolefin, polyamide, polyurethane, polyester, acrylic, epoxy, oleoresin, vinyl, or any combination thereof.

Example 9. The method of any one of examples herein, particularly example 8, where the at least one polymeric layer further comprises one or more of crosslinking agents, plasticizers, processing aids, coloring agents, or any combination thereof.

Example 10. The method of any one of examples herein, particularly example 8 or 9, wherein the at least one polymeric layer comprises a bisphenol A-diglyceryl ether epoxy, vinyl organosols, phenolics, or any combination thereof.

Example 11. The method of any one of examples herein, particularly examples 1-10, wherein at least step c) is performed at room temperature.

Example 12. The method of any one of examples herein, particularly examples 1-11, further comprising a step of applying an ultrasonic frequency during the duration of at least step c) and/or at least step d).

Example 13. The method of any one of examples herein, particularly examples 1-12, wherein the metallic article is a food container.

Example 14. The method of any one of examples herein, particularly example 13, wherein the at least one polymeric layer has been in intimate contact with at least one food item for a second predetermined time.

Example 15. The method of any one of examples herein, particularly example 14, wherein the method comprises comparing a composition of the delaminated polymeric layer with a composition of a substantially identical virgin polymeric layer that has not been in intimate contact with the at least one food item at any time.

Example 16. A method comprising: (a) providing an electrochemical cell comprising an electrolyte solution positioned within an electronically non-conductive vessel; wherein the electrochemical cell further comprises a cathode terminal and an anode terminal; (b) positioning a metallic food container into the electrolyte solution, wherein the metallic food container is substantially empty of food items and has a first surface and a second surface, wherein at least one of the first or the second surfaces is coated with at least one polymeric layer having a predetermined thickness; and wherein the metallic food container is coupled to the cathode terminal; (c) applying a current to the metallic food container for a first predetermined time, wherein the current has a predetermined value effective to substantially delaminate the at least one polymeric layer, thereby forming the delaminated polymeric layer; (d) collecting the delaminated polymeric layer, and (e) comparing a composition of the delaminated polymeric layer with a composition of a substantially identical polymeric layer coated on the at least one of the first or the second surfaces before it contacts the food item.

Example 17. The method of any one of examples herein, particularly example 16, wherein the composition of the delaminated polymeric layer is substantially the same as a composition of the at least one polymeric layer prior to step c).

Example 18. A system comprising: an electronically non-conductive vessel comprising an electrolyte solution and wherein the electronically non-conductive vessel comprises a cathode terminal and an anode terminal; and a metallic article configured to be positioned within the electrolyte solution and be coupled to the cathode terminal; wherein the metallic article is a food container comprising at least one polymeric layer on at least one surface of the metallic article and wherein the system is configured to delaminate the at least one polymeric layer and to form at least one delaminated polymeric layer, wherein a composition of the at least one delaminated polymeric layer is substantially identical to a composition of the at least one polymeric layer.

Example 19. The system of any one of examples herein, particularly example 18, wherein the system further comprises a reference metallic article, wherein the reference metallic article is substantially free of any coatings.

Example 20. The system of any one of examples herein, particularly example 18 or 19, further comprises a control unit, wherein the control unit is configured to deliver a direct current (DC) having a value from about 2 to about 75 A to the metallic article, thereby causing delamination of the at least one polymeric layer.

Example 21. The system of any one of examples herein, particularly of examples 18-20, wherein the system further comprises an ultrasonic generator configured to provide a predetermined ultrasonic frequency.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus-or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### REFERENCES

1. Farris, S., Piergiovanni, L. 2012. Emerging coating technologies for food and beverage packaging materials, Editor(s): Kit L. Yam, Dong Sun Lee. In Woodhead Publishing Series in Food Science, Technology and Nutrition, Emerging Food Packaging Technologies. Woodhead Publishing, 2012, Pages 274-302.
2. Rahayu, E. F., Asmorowati, D. S. 2019. Review of metal corrosion on food cans. J. Phys.: Conf. Ser. 1321 (2) 022037.
3. U.S. Pat. No. 6,045,686.
4. Paul S, Sindhu T K (2014) Synthesis and characterization of epoxy-aluminum nanocomposites for energy storage applications. IEEE Trans Dielectric Electr Insul 21:2164-2171. doi: 10.1109/TDEI.2014.004595.
5. Bello S A, Agunsoye J O, Adebisi J A, et al. (2018) Optimization of tensile properties of epoxy aluminum particulate composites using regression models. J King Saud Univ-Sci. doi: 10.1016/j. jksus.2018.06.002.
6. Shi X, Nguyen T A, Suo Z, et al. (2009) Effect of nanoparticles on the anticorrosion and mechanical properties of epoxy coating. Surf Coat Technol—SURF COAT TECH 204:237-245. doi: 10.1016/j. surfcoat.2009.06.048
7. Alam M A, Samad U A, Khan R, et al. (2017) Anti-corrosive performance of epoxy coatings containing various nanoparticles for splash zone applications. Korean J Chem Eng 34:2301-2310. doi: 10.1007/s11814-017-0114-1.
8. Yang F, Liu T, Li J, et al. (2018) Anticorrosive behavior of a zinc-rich epoxy coating containing sulfonated polyaniline in 3.5% NaCl solution. RSC Adv 8:13237-13247. doi: 10.1039/C8RA00845K.
9. Mouritz A P (ed) (2012) 13—Polymers for aerospace structures. In: Introduction to Aerospace Materials. Woodhead Publishing, pp 268-302
10. Marcilla A, Beltrán M (1998) Effect of the plasticizer concentration and heating rate on the thermal decomposition behavior of PVC plastisols. Kinetic analysis. Polym Degrad Stab 60:1-10. doi: 10.1016/S0141-3910(96)00124-3.
11. Zhou J, Lucas J P (1999) Hygrothermal effects of epoxy resin. Part II: variations of glass transition temperature. Polymer 40:5513-5522. doi: 10.1016/S0032-3861(98)00791-5.
12. González M G, Cabanelas J C, Baselga J (2012) Applications of FTIR on Epoxy Resins—Identification, Monitoring the Curing Process, Phase Separation and Water Uptake. In: Theophanides T (ed) Infrared Spectroscopy—Materials Science, Engineering and Technology. InTech., pp 261-284.
13. Ma C, Zhou B, Xia D-H, et al. (2018) In-situ Study the Corrosion Degradation Mechanism of Tin-plate in Salty Water by Scanning Electrochemical Microscopy. Russ J Electrochem 54:216-223. doi: 10.1134/S1023193517120060.

1. A method comprising:
a) providing an electrochemical cell comprising an electrolyte solution positioned within an electronically non-conductive vessel; wherein the electrochemical cell further comprises a cathode terminal and an anode terminal;
b) positioning a metallic article into the electrolyte solution, wherein the metallic article has a first surface and a second surface, wherein at least one of the first or the second surfaces is coated with at least one polymeric layer having a predetermined thickness; and wherein the metallic article is coupled to the cathode terminal;
c) applying a current to the metallic article for a first predetermined time, wherein the current has a predetermined value effective to substantially delaminate the at least one polymeric layer, thereby forming a delaminated polymeric layer; and
d) collecting the delaminated polymeric layer, wherein a composition of the delaminated polymeric layer is substantially the same as a composition of the at least one polymeric layer.

2. The method of claim 1, wherein the anode terminal is coupled to a reference metallic article, wherein the reference metallic article is substantially free of any coatings.

3. The method of claim 1, wherein the current is a direct current (DC) and has a value from about 2 to about 75 A.

4. The method of claim 1, wherein the metallic article is a tin-coated steel article.

5. The method of claim 1, wherein the first predetermined time is from about 1 s to about 24 hours.

6. The method of claim 1, wherein the electrolyte solution has a pH from about 5.5 to about 8.

7. The method of claim 1, wherein the electrolyte solution is not a strong acid or a caustic solution.

8. The method of claim 1, wherein the at least one polymeric layer comprises one or more of polyolefin, polyamide, polyurethane, polyester, acrylic, epoxy, oleoresin, vinyl, or any combination thereof.

9. The method of claim 8, where the at least one polymeric layer further comprises one or more of crosslinking agents, plasticizers, processing aids, coloring agents, or any combination thereof.

10. The method of claim 8, wherein the at least one polymeric layer comprises a bisphenol A-diglyceryl ether epoxy, vinyl organosols, phenolics, or any combination thereof.

11. The method of claim 1, wherein at least step c) is performed at room temperature.

12. The method of claim 1, further comprising a step of applying an ultrasonic frequency during the duration of at least step c) and/or at least step d).

13. The method of claim 1, wherein the metallic article is a food container, and wherein the at least one polymeric layer has been in intimate contact with at least one food item for a second predetermined time.

14. (canceled)

15. The method of claim 13, wherein the method comprises comparing a composition of the delaminated polymeric layer with a composition of a substantially identical virgin polymeric layer that has not been in intimate contact with the at least one food item at any time.

16. A method comprising:
a) providing an electrochemical cell comprising an electrolyte solution positioned within an electronically non-conductive vessel; wherein the electrochemical cell further comprises a cathode terminal and an anode terminal;
b) positioning a metallic food container into the electrolyte solution, wherein the metallic food container is substantially empty of food items and has a first surface and a second surface, wherein at least one of the first or the second surfaces is coated with at least one polymeric layer having a predetermined thickness; and wherein the metallic food container is coupled to the cathode terminal;
c) applying a current to the metallic food container for a first predetermined time, wherein the current has a predetermined value effective to substantially delaminate the at least one polymeric layer, thereby forming the delaminated polymeric layer;
d) collecting the delaminated polymeric layer, and
e) comparing a composition of the delaminated polymeric layer with a composition of a substantially identical polymeric layer coated on the at least one of the first or the second surfaces before it contacts the food item.

17. The method of claim 16, wherein the composition of the delaminated polymeric layer is substantially the same as a composition of the at least one polymeric layer prior to step c).

18. A system comprising:
an electronically non-conductive vessel comprising an electrolyte solution and wherein the electronically non-conductive vessel comprises a cathode terminal and an anode terminal; and
a metallic article configured to be positioned within the electrolyte solution and be coupled to the cathode terminal; wherein the metallic article is a food container comprising at least one polymeric layer on at least one surface of the metallic article and wherein the system is configured to delaminate the at least one polymeric layer and to form at least one delaminated polymeric layer, wherein a composition of the at least one delaminated polymeric layer is substantially identical to a composition of the at least one polymeric layer.

19. The system of claim 18, wherein the system further comprises a reference metallic article, wherein the reference metallic article is substantially free of any coatings.

20. The system of claim 18, further comprises a control unit, wherein the control unit is configured to deliver a direct current (DC) having a value from about 2 to about 75 A to the metallic article, thereby causing delamination of the at least one polymeric layer.

21. The system of claim 18, wherein the system further comprises an ultrasonic generator configured to provide a predetermined ultrasonic frequency.
